(19) United States
(12) Patent Application Publication
(10) Pub. No.: US 2012/0193350 A1
(43) Pub. Date: Aug. 2, 2012

(54) BAG FOR MICROWAVE POPCORN PRODUCT

(75) Inventors: Tony Swingley, Noblesville, IN (US); David Bradley, Naples, FL (US)

(73) Assignee: WEAVER POPCORN COMPANY, INC., Noblesville, IN (US)

(21) Appl. No.: 13/018,809

(22) Filed: Feb. 1, 2011

(51) Int. Cl. H05B 6/80; B65B 43/02

(52) U.S. Cl. 219/727; 53/455

(57) ABSTRACT

A bag is provided for use with a microwave popcorn product. A method and a system for manufacturing and filling the bag are also provided. An exemplary bag may include a base, a first side, and a second side that cooperate to define a pocket for receiving the popcorn product.

### BACKGROUND

The present disclosure relates to a bag for use with a microwave popcorn product. The present disclosure also relates to a method and a system for manufacturing and filling the bag.

Known microwave popcorn products may include popcorn kernels, oil, and selected amounts of salt and natural and/or artificial flavors and colors packaged together in a microwavable paper bag.

Upon heating the bag in a microwave oven, the popcorn kernels in the bag pop and release steam, causing the bag to inflate. Also, the oil in the bag melts and disperses, along with other ingredients such as salt, flavors, and colors, to cover the popped popcorn.

To consume the popped popcorn, a consumer may open the bag and reach directly into the bag. Alternatively, the consumer may open the bag and dump the popped popcorn from the bag into a bowl, for example.

### SUMMARY

The present disclosure provides a bag for use with a microwave popcorn product. The present disclosure also provides a method and a system for manufacturing and filling the bag. An exemplary bag may include a base, a first side, and a second side that cooperate to define a pocket for receiving the popcorn product.

According to an embodiment of the present disclosure, a bag is provided that is configured for heating in a microwave oven to prepare a popcorn product, the bag transitioning between a folded state before heating in the microwave oven to an inflated state after heating in the microwave oven. The bag includes a base, a first side extending from the base along a first corner fold, a second side extending from the base along a second corner fold, the first and second sides cooperating to define an opening into the bag, and at most one gusset fold that extends substantially parallel to the first and second corner folds, the at most one gusset fold being located in either the first side or the second side of the bag.

According to another embodiment of the present disclosure, a bag is provided that is configured for heating in a microwave oven to prepare a popcorn product, the bag transitioning between a folded state before heating in the microwave oven to an inflated state after heating in the microwave oven. The bag includes a base, a first side extending from the base, a second side extending from the base, the first and second sides cooperating to define an opening into the bag, and a pocket seal that divides the bag into a first pocket and a second pocket in the folded state, the bag opening along the pocket seal in the inflated state.

According to yet another embodiment of the present disclosure, a bag is provided that is configured for heating in a microwave oven to prepare a popcorn product, the bag transitioning between a folded state before heating in the microwave oven to an inflated state after heating in the microwave oven. The bag includes a base, a first side extending from the base to a top end of the bag, the first side having a first adhesive field, and a second side extending from the base to the top end of the bag, the second side having a second adhesive field that cooperates with the first adhesive field to releasably seal the first and second sides together along the top end of the bag, at least one of the first and second adhesive fields being segmented.

According to still yet another embodiment of the present disclosure, a method is provided for producing a microwave popcorn bag. The method includes the steps of: providing a sheet; folding the sheet to form a first corner fold, the first corner fold being located between a base of the bag and a first side of the bag; folding the sheet to form a second corner fold, the second corner fold being located between the base of the bag and a second side of the bag, the first and second sides cooperating to define an opening into the bag; and folding the sheet to form at most one gusset fold that extends substantially parallel to the first and second corner folds, the at most one gusset fold being located in either the first side or the second side of the bag.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 is a perspective view of an exemplary microwave popcorn bag of the present disclosure, the microwave popcorn bag shown in an inflated state after heating in a microwave oven;

FIG. 2 is an elevational view of a front end of the microwave popcorn bag of FIG. 1;

FIG. 3 is a top plan view of the microwave popcorn bag of FIG. 1, the microwave popcorn bag shown in a closed state;

FIG. 4 is a top plan view similar to FIG. 3 with the microwave popcorn bag shown in an open state to reveal popped popcorn within the bag;

FIG. 5 is a plan view of an inner surface of the microwave popcorn bag of FIG. 1, the microwave popcorn bag shown in an unfolded state;

FIG. 6 is a plan view similar to FIG. 5 showing a first corner fold formed in the microwave popcorn bag;

FIG. 7 is a plan view similar to FIG. 6 showing a gusset fold formed in the microwave popcorn bag;

FIG. 8 is a plan view similar to FIG. 7 showing a second corner fold formed in the microwave popcorn bag, the microwave popcorn bag shown after being sealed along its front and back ends and at a location between its front and back ends;

FIG. 9A is an elevational view of the back end of the microwave popcorn bag, the microwave popcorn bag being filled with popcorn kernels;

FIG. 9B is an elevational view similar to FIG. 9A showing the microwave popcorn bag being filled with an oil blend;

FIG. 10 is a top plan view of the microwave popcorn bag after being filled with popcorn kernels and the oil blend;

FIG. 11 is a plan view similar to FIG. 8 showing the microwave popcorn bag after being sealed along a top end;

FIG. 12 is a plan view similar to FIG. 11 showing a cross fold formed in the microwave popcorn bag to place the microwave popcorn bag in a folded state; and

FIG. 13 is a schematic diagram of an exemplary system of the present disclosure for carrying out the method of FIGS. 5-12.

Corresponding reference characters indicate corresponding parts throughout the views. The exemplifications set out herein illustrate embodiments of the disclosure, and such exemplifications are not to be construed as limiting the scope of the invention any manner.

### DETAILED DESCRIPTION

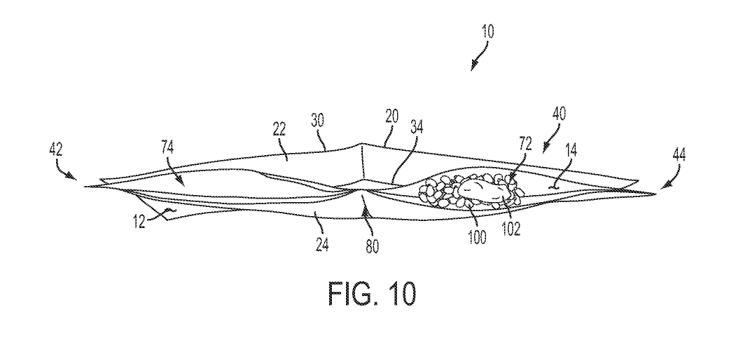

Bag 10 is provided for use with a microwave popcorn product. Initially, bag 10 may be provided in a fully or partially folded state, as shown in FIGS. 10-12. When bag 10 is in this folded state, the popcorn product in bag 10 may include primarily unpopped popcorn kernels 100 and a blend 102 that includes oil and other materials such as salt, flavors, and/or colors. Upon heating bag 10 in a microwave oven, popcorn kernels 100 in bag 10 may pop and the blend 102 in bag 10 may melt and disperse throughout bag 10. As a result of this popping process, bag 10 may expand to an inflated state, as shown in FIGS. 1-4. When bag 10 is in this inflated state, the popcorn product in bag 10 may include primarily popped popcorn 104 and dispersed oil (not shown).

Bag 10 may be made of paper or another suitable material that is able to withstand elevated temperatures when heating in a microwave oven. In certain embodiments, the paper may be able to withstand temperatures above 350° F. An exemplary paper is a 2-ply, natural Kraft paper having a base weight of about 21 lb. and is available from Gascogne Paper of Mérignac Cedex, France. The plies of the paper may be secured together with a suitable adhesive, such as ethylene vinyl acetate (EVA). Also, one or both sides of the paper may be coated, glazed, or laminated to minimize wicking of the popcorn product, especially the blend 102, through the paper of bag 10. Suitable coatings include, for example, polyesters and polyolefins.

Bag 10 includes outer surface 12 that faces outward toward a consumer and an opposing inner surface 14 that faces inward toward the popcorn product. Outer surface 12 of bag 10 that faces the consumer may be labeled with cooking instructions, manufacturing information, nutritional information, or other information for the consumer. Inner surface 14 of bag 10 that faces the popcorn product may include suitable adhesives or sealants, as discussed further below, to hold bag 10 together. As mentioned above, outer surface 12 and/or inner surface 14 of bag 10 may be coated, glazed, or laminated to minimize wicking of the popcorn product, especially the blend 102, through bag 10.

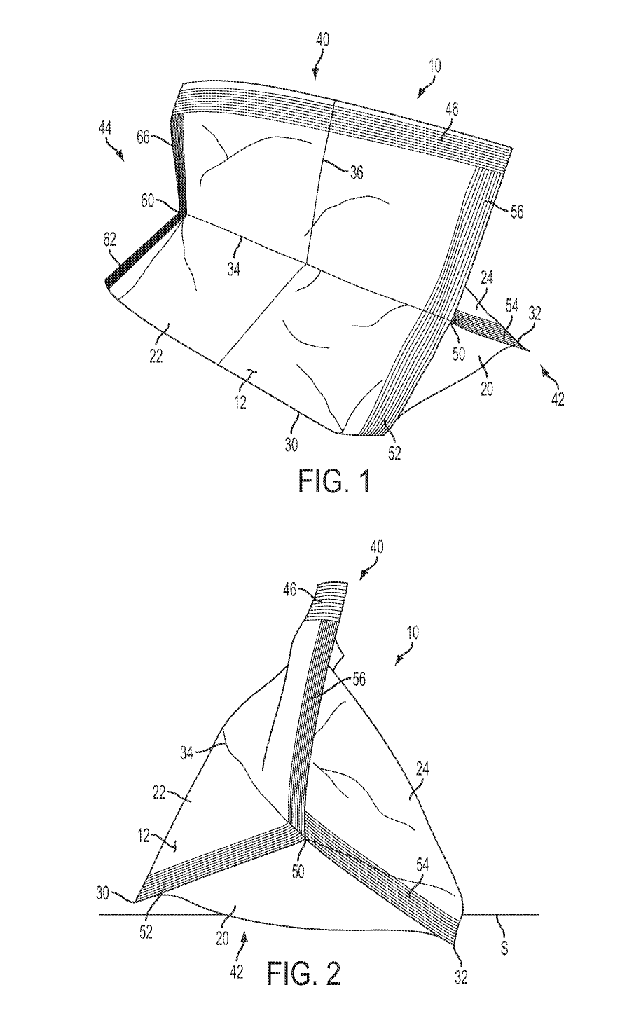

Bag 10 may be creased or folded to form base 20, first side 22, and second side 24. As shown in FIG. 2, first corner fold 30 extends along the intersection between base 20 and first side 22 and second corner fold 32 extends along the intersection between base 20 and second side 24. In the inflated state of FIGS. 1-4, base 20, first side 22, and second side 24 of bag 10 spread apart along first corner fold 30 and second corner fold 32 to define a substantially triangular shape.

The size of bag 10 may vary depending on the quantity of popcorn product to be provided in bag 10. In an exemplary embodiment, base 20 of bag 10 spans approximately 5.5″ between first corner fold 30 and second corner fold 32, first side 22 of bag 10 spans approximately 6.25″ away from first corner fold 30, and second side 24 of bag 10 spans slightly less than 6.25″ away from second corner fold 32, such as 6.125″ away from second corner fold 32. However, it is within the scope of the present disclosure that the relative dimensions of base 20, first side 22, and second side 24 of bag 10 may vary.

With base 20 of bag 10 resting on a countertop, a tabletop, or another surface S, as shown in FIG. 2, top end 40 of bag 10 extends upward from surface S. Top end 40 of bag 10 spans across bag 10 from front end 42 to back end 44 of bag 10. Although the size of bag 10 may vary, an exemplary bag 10 spans approximately 10.5″ between front end 42 and back end 44.

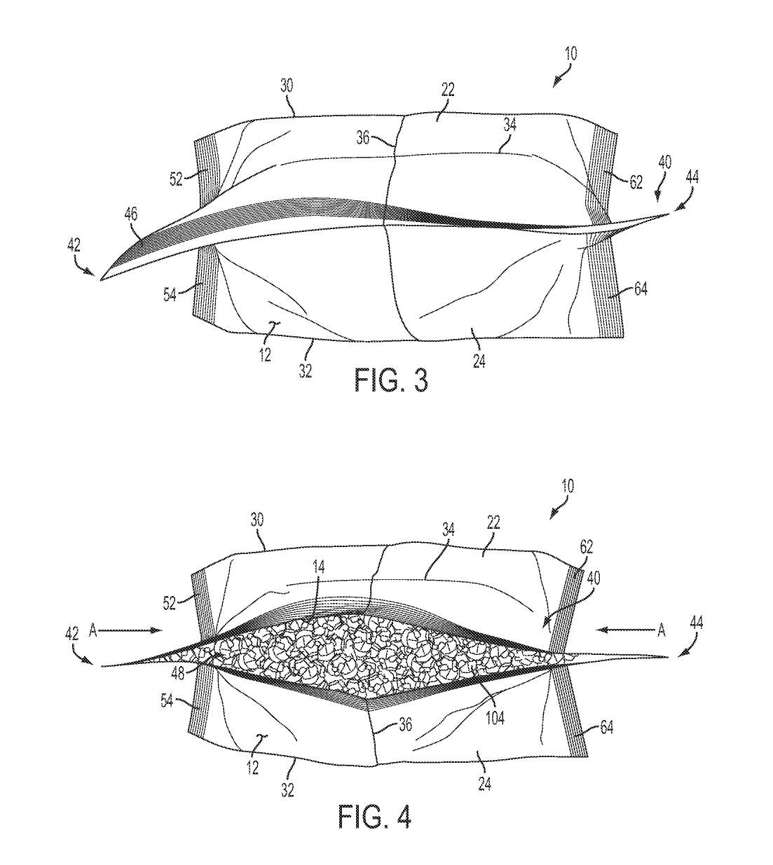

Top end 40 of bag 10 is cooperatively defined by first side 22 and second side 24 of bag 10. Before the popping process, first side 22 and second side 24 of bag 10 are sealed together along top end 40 with top seal 46, as shown in FIG. 3. During the popping process, excess steam may escape or vent through top seal 46 of bag 10. After the popping process, the consumer may open top seal 46 of bag 10.

To open top seal 46 of bag 10, the consumer forms opening 48 between first side 22 and second side 24 of bag 10, as shown in FIG. 4. An exemplary method of opening top seal 46 involves pushing front end 42 and back end 44 of bag 10 together along arrows A, forcing first side 22 and second side 24 of bag 10 apart. With base 20 of bag 10 facing downward and opening 48 in bag 10 facing upward, bag 10 may serve as a bowl that is able to rest upright on surface S, as shown in FIG. 2. In this arrangement, the consumer is able to reach downward into bag 10 through opening 48 without having to hold bag 10 upright. Also, popped popcorn 104 may be prevented from falling out of an open side of bag 10, instead remaining cupped inside bag 10.

Front end 42 of bag 10 is cooperatively defined by base 20, first side 22, and second side 24 of bag 10. As shown in FIG. 2, base 20, first side 22, and second side 24 of bag 10 all come together near center 50 of front end 42. As base 20, first side 22, and second side 24 of bag 10 approach center 50 of front end 42, adjacent portions of bag 10 are sealed together. More specifically, base 20 and first side 22 of bag 10 are sealed together approaching center 50 with seal 52, base 20 and second side 24 of bag 10 are sealed together approaching center 50 with seal 54, and first side 22 and second side 24 of bag 10 are sealed together approaching center 50 with seal 56.

Back end 44 of bag 10 may be a mirror-image of front end 42 of bag 10, which is shown in FIG. 2. Like front end 42 of bag 10, back end 44 of bag 10 is also cooperatively defined by base 20, first side 22, and second side 24 of bag 10. Base 20, first side 22, and second side 24 of bag 10 all come together near center 60 of back end 44. As base 20, first side 22, and second side 24 of bag 10 approach center 60 of back end 44, adjacent portions of bag 10 are sealed together. More specifically, base 20 and first side 22 of bag 10 are sealed together approaching center 60 with seal 62, base 20 and second side 24 of bag 10 are sealed together approaching center 60 with seal 64, and first side 22 and second side 24 of bag 10 are sealed together approaching center 60 with seal 66.

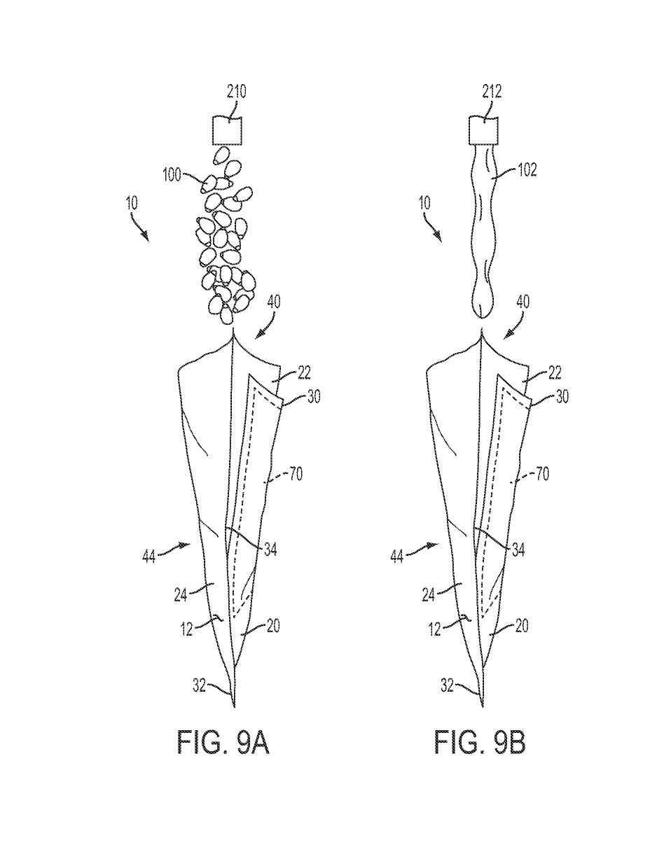

Bag 10 may include gusset fold 34 to provide a compact product for packaging and shipping. In the illustrated embodiment of FIG. 2, for example, first side 22 of bag 10 includes gusset fold 34. However, it is within the scope of the present disclosure that base 20 or second side 24 of bag 10 may include gusset fold 34. The illustrated gusset fold 34 extends along first side 22 of bag 10 from center 50 of front end 42 to center 60 of back end 44 and in a direction substantially parallel to first corner fold 30 and second corner fold 32, such that bag 10 includes 3 substantially parallel folds. When bag 10 is in the folded state, as shown in FIGS. 9A and 9B, first side 22 of bag 10 may tuck inward along gusset fold 34. As bag 10 expands to the inflated state, as shown in FIG. 2, first side 22 of bag 10 may unfold along gusset fold 34 to provide more area for the expanding popcorn product contained therein.

Bag 10 may also include one or more cross folds 36 to provide a compact product for packaging and shipping. In the illustrated embodiment of FIG. 1, for example, bag 10 includes a single cross fold 36 that is located approximately halfway between front end 42 and back end 44 of bag 10, enabling bag 10 to be folded in half. If bag 10 spans approximately 10.5″ between front end 42 and back end 44, for example, cross fold 36 may be located approximately 5.25″ from both front end 42 and back end 44 of bag 10. It is also within the scope of the present disclosure that bag 10 may include more than one cross fold, enabling bag 10 to be folded in thirds or quarters, for example. Cross fold 36 extends in a direction substantially perpendicular to first corner fold 30, second corner fold 32, and gusset fold 34. In the folded state of FIG. 12, bag 10 may be wrapped in plastic overwrap and packaged in a box or another suitable container for shipping and storage.

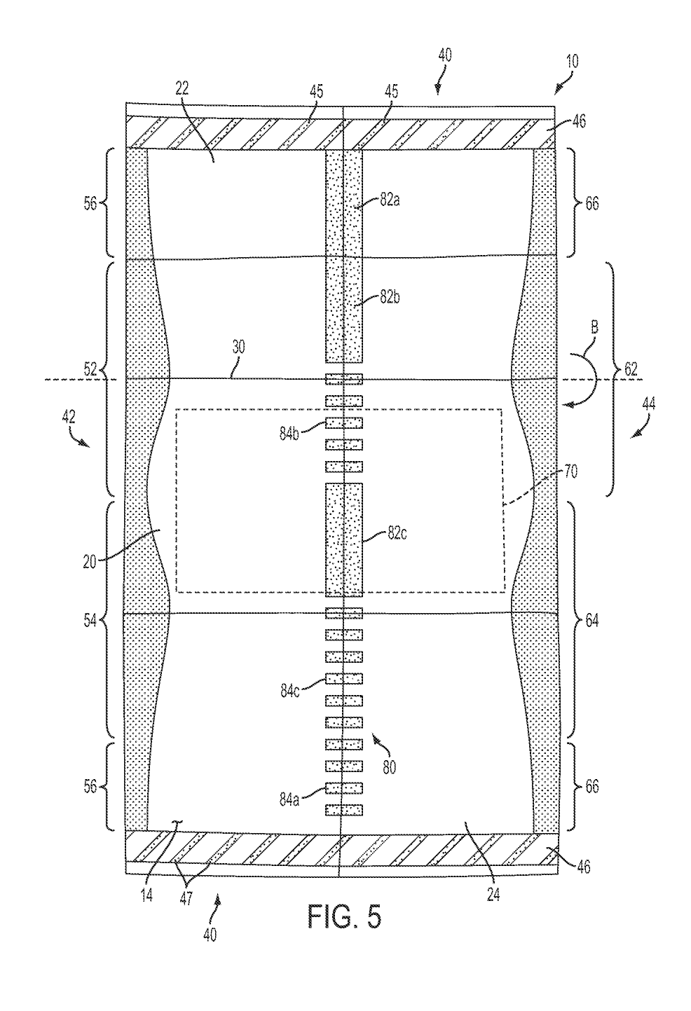

Bag 10 further includes susceptor 70, which is shown in phantom in FIG. 5. Susceptor 70 may be a thin, metal-coated polyester film, such as an aluminum-coated polyethylene terephthalate (PET) film, or a silicon-coated PET film, for example. As shown in FIG. 5, susceptor 70 is embedded between the plies of bag 10, and specifically between the plies of base 20 of bag 10. If base 20 of bag 10 spans approximately 5.5″ between first corner fold 30 and second corner fold 32 and approximately 10.5″ between front end 42 and back end 44, susceptor 70 may be substantially rectangular in shape and sized less than 5.5″ by 10.5″, such as 4.75″ by 6.0″. During the popping process, susceptor 70 absorbs microwave energy and concentrates heat across its surface, thereby heating the contents of bag 10.

To prepare and consume the popcorn product in bag 10, a consumer may remove any plastic overwrap from bag 10 and unfold bag 10 along cross fold 36. Then, the consumer may place bag 10 in a microwave oven with base 20 of bag 10 facing downward. Because base 20 of bag 10 contains susceptor 70, susceptor 70 will also rest downward in the microwave oven. After heating bag 10 in the microwave oven for a suitable time, such as about 1.5 minutes, 2 minutes, 2.5 minutes, or 3 minutes, for example, the consumer may allow bag 10 and its contents to cool and then remove bag 10 from the microwave oven. Finally, the consumer may open bag 10 along top seal 46 and consume the popped popcorn 104 therein (FIG. 4).

To facilitate filling bag 10 with unpopped popcorn kernels 100 and the blend 102, as discussed further below, bag 10 may be divided initially into one or more pockets 72, 74, as shown in FIG. 10. Susceptor 70 may span across one or both pockets 72, 74. To create pockets 72, 74, the illustrative bag 10 initially includes an interior pocket seal 80 that is located approximately halfway between front end 42 and back end 44 of bag 10.

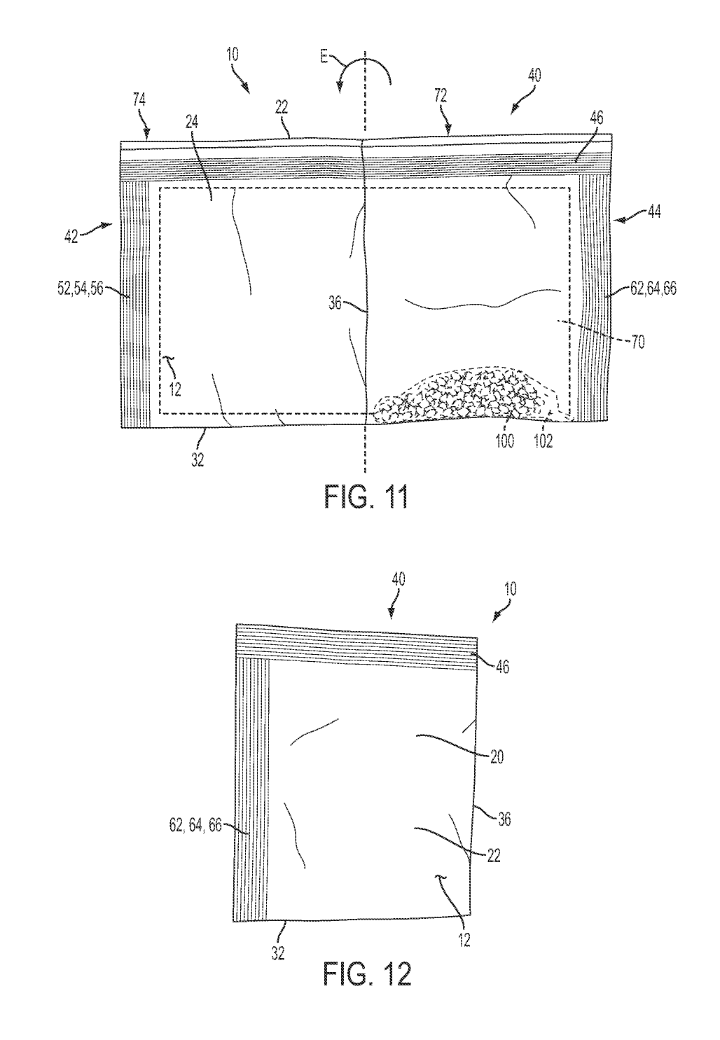

During the filling process, unpopped popcorn kernels 100 and the blend 102 may be loaded into one pocket (e.g., pocket 72) and the other pocket (e.g., pocket 74) may be left empty, as shown in FIG. 11. If susceptor 70 spans across only one pocket, unpopped popcorn kernels 100 and the blend 102 should be loaded into the pocket that contains susceptor 70 to promote heating of the ingredients. It is also within the scope of the present disclosure that unpopped popcorn kernels 100 and the blend 102 may be loaded into both pockets 72, 74, especially if susceptor 70 spans across both pockets 72, 74.

During the popping process, the building pressure inside bag 10 causes bag 10 to open along pocket seal 80, thereby converting bag 10 from a two-pocket package to a single-pocket package and exposing the once-empty pocket (e.g., pocket 74) to the expanding popcorn product contained within bag 10, as shown in FIG. 4. To facilitate the opening of pocket seal 80 during the popping process, susceptor 70, which absorbs microwave energy, may be located adjacent to pocket seal 80 to concentrate heat near pocket seal 80. According to an exemplary embodiment of the present disclosure, bag 10 may begin to open along pocket seal 80 after being heated in a microwave oven for as few as 30 seconds, 45 seconds, 60 seconds, or 75 seconds, for example. Although susceptor 70 may be located adjacent to pocket seal 80, susceptor 70 may be spaced apart from front seals 52, 54, 56, and back seals 62, 64, 66, to avoid opening front end 42 and back end 44 of bag 10 during the popping process.

Referring next to FIGS. 5-12, an exemplary process is illustrated for manufacturing and filling bag 10. Although only a single bag 10 is shown in FIGS. 5-12, the following process may be conducted using a continuous spool of paper that is later sliced at a suitable point in the process to form each individual bag 10. Processing a continuous spool of paper, rather than discrete, individual bags 10, significantly increases the speed and efficiency of the process.

Bag 10 begins as a flat sheet of paper in FIG. 5. Inner surface 14 of bag 10 is shown in FIG. 5. As discussed above, inner surface 14 of bag 10 will eventually face inward toward the popcorn product in bag 10. Inner surface 14 of bag 10 includes fields of a suitable adhesive or sealant at predetermined locations to hold bag 10 together. For example, inner surface 14 of bag 10 may include adhesive fields at the following locations: top seal 46 along top end 40 of bag 10, front seals 52, 54, 56, along front end 42 of bag 10, back seals 62, 64, 66, along back end 44 of bag 10, and pocket seal 80 along the middle of bag 10.

The size and shape of each adhesive field may vary depending on the desired strength of the corresponding seal. For example, the adhesive fields that form front seals 52, 54, 56, on front end 42 of bag 10 and back seals 62, 64, 66, on back end 44 of bag 10, may be large in total surface area and/or continuous. Once sealed, the large and/or continuous adhesive fields may promote strong front seals 52, 54, 56, and strong back seals 62, 64, 66, which may prevent air from venting through front end 42 and back end 44 of bag 10 and which may prevent the popcorn product from falling out of front end 42 and back end 44 of bag 10. Although the adhesive fields that form front seals 52, 54, 56, and back seals 62, 64, 66, are illustrated in an undulating pattern along front end 42 and back end 44 of bag 10, it is also within the scope of the present disclosure that these adhesive fields may be substantially linear.

Unlike the continuous adhesive fields that form front seals 52, 54, 56, and back seals 62, 64, 66, the adhesive fields that form top seal 46 and pocket seal 80 may be small in total surface area and/or segmented. For example, top seal 46 may include spaced-apart or segmented fields 45 on first side 22 of bag 10 and corresponding segmented fields 47 on second side 24 of bag 10. Segmented fields 45 on first side 22 of bag 10 may be at least partially offset from the corresponding segmented fields 47 on second side 24 of bag 10 so that, when bag 10 is folded together, at least certain portions of segmented fields 45 on first side 22 of bag 10 interface with bare paper (i.e., not adhesive) located between segmented fields 47 on second side 24 of bag 10, and vice versa. As shown in FIG. 5, for example, segmented fields 45, 47, may cooperate to form X-shaped patterns when bag 10 is folded together, such that certain portions of segmented fields 45 interface with bare paper located between segmented fields 47 and other portions of segmented fields 45 interface directly with the adhesive of segmented fields 47. This discontinuous interaction between segmented fields 45, 47, may promote a partial or incomplete top seal 46 to limit the strength of top seal 46, enabling bag 10 to vent along top seal 46 during the popping process and enabling the consumer to easily open top seal 46 after the popping process. The strength of top seal 46 may be controlled by varying the size of segmented fields 45, 47, and the spacing between adjacent segmented fields 45, 47, for example.

As another example, pocket seal 80 may include continuous fields 82a, 82b, 82c, and corresponding segmented fields 84a, 84b, 84c. When bag 10 is folded, certain portions of continuous fields 82a, 82b, 82c, may interface with bare paper (i.e., not adhesive) between the corresponding segmented fields 84a, 84b, 84c. This discontinuous interaction between continuous fields 82a, 82b, 82c, and segmented fields 84a, 84b, 84c, may promote a partial or incomplete pocket seal 80 to limit the strength of pocket seal 80, enabling bag 10 to open along pocket seal 80 as pressure builds in bag 10 during the popping process. The strength of pocket seal 80 may be controlled by varying the size of segmented fields 84a, 84b, 84c, and the spacing between adjacent segmented fields 84a, 84b, 84c, for example.

By varying the size and shape of each adhesive field, the strength of the corresponding seal may be controlled without having to vary the type of adhesive used and/or the thickness of each adhesive layer. For example, the same type and thickness of adhesive may be used to form top seal 46, front seals 52, 54, 56, back seals 62, 64, 66, and pocket seal 80 of bag 10, but top seal 46 and pocket seal 80 may be made relatively weak compared to front seals 52, 54, 56, and back seals 62, 64, 66, by varying the size and shape of the corresponding adhesive fields. Maintaining a consistent type and/or thickness of adhesive may improve the speed and cost of the manufacturing process. A suitable heat seal adhesive that may be used to form top seal 46, front seals 52, 54, 56, back seals 62, 64, 66, and pocket seal 80 of bag 10, includes, for example, polyvinyl acetate (PVA).

It is also within the scope of the present disclosure that the type and thickness of adhesive used in each adhesive field may vary depending on the desired strength of the corresponding seal. For example, a relatively weak adhesive (i.e., an adhesive having a low melting point) and/or thin layer of adhesive may be used to form top seal 46 along top end 40 of bag 10 so that bag 10 is able to vent through top seal 46. On the other hand, a relatively strong adhesive (i.e., an adhesive having a high melting point) and/or thick layer of adhesive may be used to form front seals 52, 54, 56, along front end 42 of bag 10 and back seals 62, 64, 66, along back end 44 of bag 10 to hold bag 10 together at these locations and to prevent the popcorn product from falling out of front end 42 or back end 44 of bag 10.

In FIG. 5, bag 10 is oriented with first side 22 of bag 10 on top, second side 24 of bag 10 on bottom, and base 20 of bag 10 between first side 22 and second side 24 of bag 10. However, it is within the scope of the present disclosure that bag 10 may be oriented in different directions throughout this process. A first folding step of the exemplary process involves folding first side 22 of bag 10 downward onto base 20 of bag 10 about axis B to form first corner fold 30.

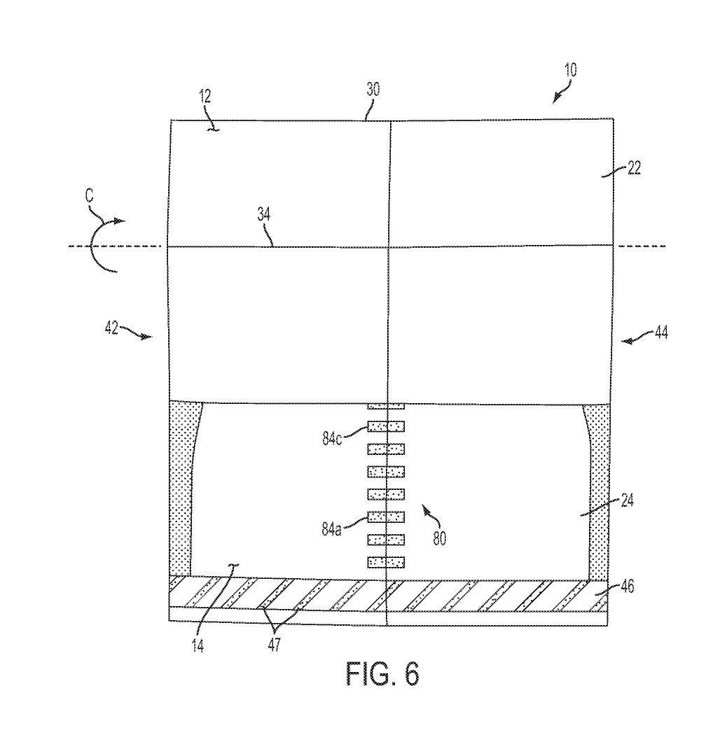

Continuing to FIG. 6, first side 22 of bag 10 has been folded downward to form first corner fold 30. A second folding step of the exemplary process involves folding first side 22 of bag 10 upward about axis C to form gusset fold 34 in first side 22 of bag 10.

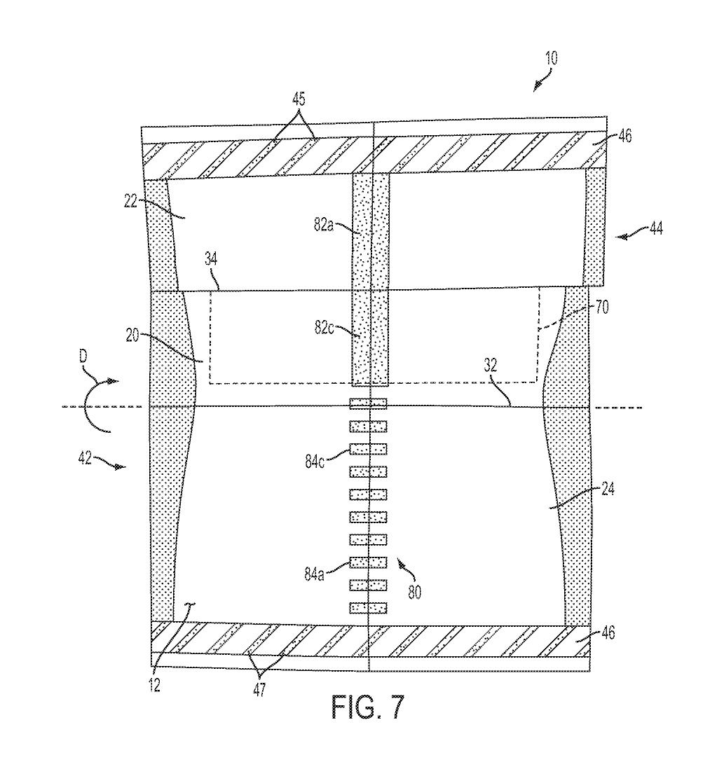

Moving on to FIG. 7, first side 22 of bag 10 has been folded upward to form gusset fold 34. In its current state, first side 22 of bag 10 is located atop base 20 of bag 10. A third folding step of the exemplary process involves folding second side 24 of bag 10 upward onto base 20 and first side 22 about axis D to form second corner fold 32.

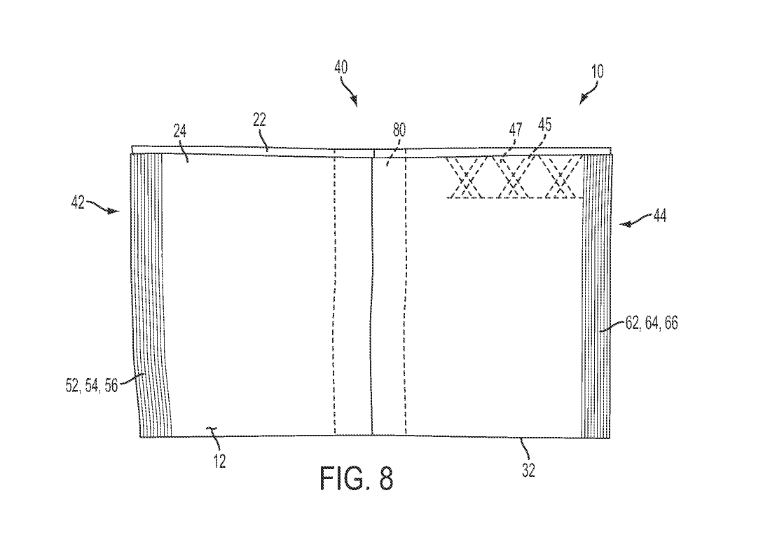

Continuing to FIG. 8, second side 24 of bag 10 has been folded upward to form second corner fold 32. In its current state, base 20, first side 22, and second side 24 of bag 10 are aligned along front end 42 and back end 44, so front seals 52, 54, 56, and back seals 62, 64, 66, are ready to be formed. Additionally, continuous fields 82a, 82b, 82c, and corresponding segmented fields 84a, 84b, 84c, of pocket seal 80 are aligned approximately halfway between front end 42 and back end 44 of bag 10, so pocket seal 80 is ready to be formed. Therefore, before any additional folding steps, a first sealing step of the exemplary process may be performed by applying heat and/or pressure to bag 10 along front end 42, back end 44, and approximately halfway between front end 42 and back end 44 to close front seals 52, 54, 56, back seals 62, 64, 66, and pocket seal 80. To enhance the strength of front seals 52, 54, 56, and back seals 62, 64, 66, relative to pocket seal 80, more heat and/or pressure may be applied to front end 42 and back end 44 of bag 10 than to the middle of bag 10. For example, as shown in FIG. 8, bag 10 may be frictionally crimped along front end 42 and back end 44, but such crimping may be avoided in the middle of bag 10.

After forming front seals 52, 54, 56, back seals 62, 64, 66, and pocket seal 80, bag 10 may be opened for filling. As shown in FIG. 8, first side 22 of bag 10 may be slightly taller than second side 24 of bag 10, or vice versa. For example, first side 22 of bag 10 may be taller than second side 24 of bag 10 by approximately 0.10″, 0.15″, 0.20″, or more. This difference in height between first side 22 and second side 24 of bag 10 creates an offset that facilitates opening of bag 10. For example, as an air injection nozzle, a mechanical opener, or another suitable opening device is lowered toward bag 10, the device may catch on the shorter, second side 24 of bag 10.

Moving on to FIGS. 9A and 9B, bag 10 may be conveyed to first filling station 210 for filling with popcorn kernels 100 and to a second filling station 212 for filling with the blend 102. Although first filling station 210 and second filling station 212 are shown in series in FIGS. 9A and 9B, it is within the scope of the present disclosure that bag 10 may be opened and filled at a single station. By injecting popcorn kernels 100 into bag 10 before or while injecting the blend 102 into bag 10, the blend 102 may rest atop or between popcorn kernels 100, thereby limiting contact between the blend 102 and bag 10 to reduce wicking.

As shown in FIG. 10, top end 40 of bag 10 may be divided into pockets 72, 74. In certain embodiments, popcorn kernels 100 and the blend 102 may be injected into one pocket of bag 10 (e.g., pocket 72) and the other pocket of bag 10 (e.g., pocket 74) may be left empty. Dividing top end 40 of bag 10 into pockets 72, 74, improves the process of filling bag 10. First, dividing top end 40 of bag 10 into pockets 72, 74, decreases the space required to open bag 10. Without pocket seal 80, first side 22 and second side 24 are able to separate a significant distance when bag 10 is opened, such as when air is injected into bag 10 or when front end 42 and back end 44 of bag 10 are forced together. However, with pocket seal 80, the separation between first side 22 and second side 24 is limited. Second, dividing top end 40 of bag 10 into pockets 72, 74, decreases the time required to open bag 10. For example, if pressurized air is injected into bag 10 to open bag 10, the system only needs to open one pocket of bag 10 (e.g., pocket 72), not the entire bag 10.

Continuing to FIG. 11, after filling bag 10, a second sealing step of the exemplary process may be performed by applying heat and/or pressure to first side 22 and second side 24 of bag 10 along top end 40 to close top seal 46. This second sealing step may ensure that bag 10 fully encloses popcorn kernels 100 and the blend 102. According to an exemplary embodiment of the present disclosure, and as shown in FIGS. 9A and 9B, first side 22 and second side 24 of bag 10 may project beyond base 20 of bag 10 along top end 40 to provide adequate access to both first side 22 and second side 24 for sealing without interference from base 20.

Through the second sealing step, the process may be conducted using a continuous spool of paper. Following the second sealing step, the continuous spool of paper may be separated to form individual bags 10. For example, the continuous spool of paper may be sliced vertically to form front end 42 and back end 44 of each individual bag 10.

Then, a fourth folding step of the exemplary process may be performed, which involves folding back end 44 of bag 10 onto front end 42 of bag 10 about axis E to form cross fold 36, as shown in FIG. 11. According to an exemplary embodiment of the present disclosure, cross fold 36 may be formed under the weight of popcorn kernels 100 and the blend 102 in pocket 72.

Continuing to FIG. 12, back end 44 of bag 10 has been folded atop front end 42 of bag 10 to form cross fold 36. In this folded state, bag 10 may be wrapped in plastic overwrap and packaged in a box or another suitable container for shipping and storage.

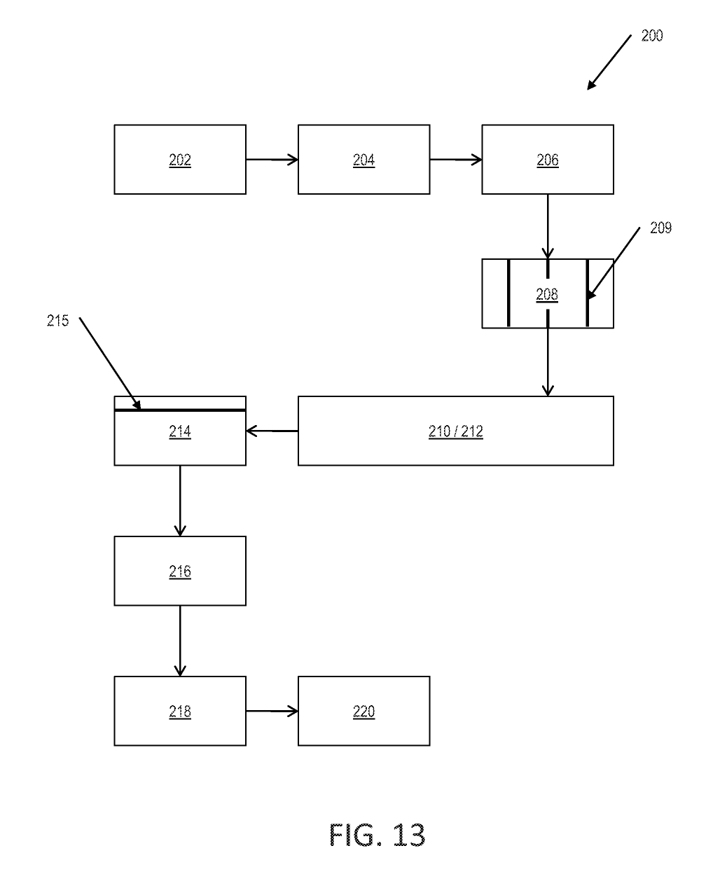

Referring next to FIG. 13, an exemplary system 200 is schematically illustrated for continuously manufacturing and filling bag 10 according to the method described above with reference to FIGS. 5-12. As discussed above, system 200 may initially process a continuous spool of paper and later form individual bags 10. System 200 of FIG. 13 includes first folder 202, second folder 204, third folder 206, first sealer 208, first and second filling stations 210, 212, second sealer 214, slicer 216, fourth folder 218, and packager 220. System 200 may further include rollers, alignment guides, tracks, and other equipment for guiding paper through system 200.

In operation, a continuous spool of paper may be conveyed continuously through system 200 beginning at first folder 202. First folder 202 of system 200 may include a crimper that is configured to form first corner fold 30 in bag 10 (FIGS. 5 and 6). From first folder 202, the paper continues to second folder 204 of system 200, which may include a crimper that is similar to first folder 202 and that is configured to form gusset fold 34 in bag 10 (FIGS. 6 and 7). From second folder 204, the paper continues to third folder 206 of system 200, which may include a crimper that is similar to first and second folders 202, 204, and that is configured to form second corner fold 32 in bag 10 (FIGS. 7 and 8). Although folders 202, 204, and 206 are shown individually in FIG. 13, it is within the scope of the present disclosure that folders 202, 204, and 206 may be part of a single folding machine.

Following folders 202, 204, 206, the paper may be conveyed to first sealer 208 of system 200 to partially close each bag 10. According to an exemplary embodiment of the present disclosure, first sealer 208 may include a plurality of vertically-oriented heat sources 209, such as heated platens or hot air dispensers, for example. Each heat source 209 of first sealer 208 may heat a vertically-oriented region of bag 10 to be sealed, such as front seals 52, 54, 56, along front end 42 of bag 10, back seals 62, 64, 66, along back end 44 of bag 10, and pocket seal 80 in the middle of bag 10 (FIG. 8). Each heat source 209 will heat and at least partially melt the adhesive located in these regions of bag 10 to seal bag 10 together. First sealer 208 may also include crimpers, presses, or other devices for applying pressure to desired regions of bag 10.

After being at least partially closed with first sealer 208, the paper may be directed to first filling station 210 and second filling station 212 for filling bag 10 with popcorn kernels 100 and the blend 102. First filling station 210 and second filling station 212 may be provided in series, as shown in FIGS. 9A and 9B, or in a single station, as shown in FIG. 13. First and second filling stations 210, 212, may be configured to open bag 10. For example, first and second filling stations 210, 212, may include an air injection nozzle, a mechanical opener, or another suitable device for opening bag 10. First and second filling stations 210, 212, may also be configured to measure and dispense metered amounts of popcorn kernels 100 and the blend 102 into bag 10. An exemplary first filling station 210 is the OYSTAR Jones Pouch King® Filler available from R.A. Jones & Co., Inc. of Covington, Ky. An exemplary second filling station 212 may be available from Pacific Packaging Machinery, Inc. of San Clemente, Calif., and may include metering pumps which are adjustable to vary the amount of the blend 102 which is injected into each bag 10.

Following first and second filling stations 210, 212, the paper may be directed to second sealer 214 of system 200 to fully close bag 10. Unlike first sealer 208, which may include vertically-oriented heat sources 209 for sealing vertically-oriented regions of bag 10, second sealer 214 may include at least one horizontally-oriented heat source 215 for closing the horizontally-oriented top seal 46 on top end 40 of bag 10 (FIG. 8). Like each heat source 209 of first sealer 208, heat source 215 of second sealer 214 may include a heated platen or a hot air dispenser, for example. Heat source 215 will heat and at least partially melt the adhesive located along top end 40 of bag 10 to seal bag 10 together. Second sealer 214 may also include crimpers, presses, or other devices for applying pressure to bag 10.

After fully closing bag 10 with second sealer 214, the paper may be accumulated to account for process downtime. Then, the paper may continue to slicer 216 of system 200. Slicer 216 may form vertically-oriented cuts in the paper to separate each individual bag 10 along front end 42 and back end 44 (FIG. 11).

The individual bags 10 from slicer 216 may continue to fourth folder 218 of system 200. Fourth folder 218 may include a crimper that is similar to folders 202, 204, 206, and that is configured to form cross fold 36 in bag 10 (FIGS. 11 and 12).

Finally, the folded and filled bag 10 may be directed to packager 220 of system 200. Packager 220 may be configured to wrap bag 10 in plastic overwrap and load bag 10 into a box or another suitable container for shipping and storage.

According to an exemplary embodiment of the present disclosure, system 200 may be configured to manufacture and fill over 1,000 microwave popcorn bags per minute. Conventional systems may be capable of manufacturing and filling less than 100 or 200 microwave popcorn bags per minute, for example. Conventional systems may be configured to handle, convey, and fill discrete, individual popcorn bags. System 200, on the other hand, may be configured to handle, convey, and fill primarily a continuous spool of paper and to later slice the paper to form individual bags 10. Another reason for the increased time required to manufacture conventional microwave popcorn bags is the number of folds. Bags 10 of the present disclosure may include as few as 3 or 4 folds (e.g., first corner fold 30, second corner fold 32, gusset fold 34, and cross fold 36), while conventional popcorn bags may require eight 8 folds, for example.

While this disclosure has been described as having a preferred design, the present invention can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains and which fall within the limits of the appended claims.

What is claimed is:

1. A bag configured for heating in a microwave oven to prepare a popcorn product, the bag transitioning between a folded state before heating in the microwave oven to an inflated state after heating in the microwave oven, the bag comprising:
a base;
a first side extending from the base along a first corner fold;
a second side extending from the base along a second corner fold, the first and second sides cooperating to define an opening into the bag; and
at most one gusset fold that extends substantially parallel to the first and second corner folds, the at most one gusset fold being located in either the first side or the second side of the bag.

2. The bag of claim 1, wherein the bag includes at most three substantially parallel folds.

3. The bag of claim 1, wherein the bag is folded along the at most one gusset fold in the folded state and unfolded along the at most one gusset fold in the inflated state to define a substantially triangular shape.

4. The bag of claim 1, further comprising at least one cross fold that extends substantially perpendicular to the first and second corner folds and to the at most one gusset fold.

5. The bag of claim 1, wherein the first and second sides of the bag are sealed together in the folded state and separable in the inflated state.

6. The bag of claim 1, wherein the first side is taller than the second side to define an offset between the first and second sides.

7. The bag of claim 6, further comprising a susceptor located within the base of the bag.

8. A bag configured for heating in a microwave oven to prepare a popcorn product, the bag transitioning between a folded state before heating in the microwave oven to an inflated state after heating in the microwave oven, the bag comprising:
a base;
a first side extending from the base;
a second side extending from the base, the first and second sides cooperating to define an opening into the bag; and
a pocket seal that divides the bag into a first pocket and a second pocket in the folded state, the bag opening along the pocket seal in the inflated state.

9. The bag of claim 8, wherein the popcorn product is located in the first pocket when the bag is in the folded state.

10. The bag of claim 9, wherein the second pocket is empty when the bag is in the folded state.

11. The bag of claim 8, further comprising a susceptor located within the base of the bag.

12. The bag of claim 11, wherein the susceptor spans across the pocket seal.

13. The bag of claim 8, further comprising a plurality of front seals between the base, the first side, and the second side along a front end of the bag and a plurality of back seals between the base, the first side, and the second side along a back end of the bag, wherein the pocket seal is weaker than the plurality of front seals and the plurality of back seals.

14. The bag of claim 13, further comprising a top seal between the first side and the second side along a top end of the bag, wherein the top seal is weaker than the plurality of front seals and the plurality of back seals.

15. The bag of claim 13, further comprising a susceptor that is spaced apart from the plurality of front seals and the plurality of back seals.

16. The bag of claim 8, wherein the pocket seal includes a plurality of segmented adhesive fields.

17. A bag configured for heating in a microwave oven to prepare a popcorn product, the bag transitioning between a folded state before heating in the microwave oven to an inflated state after heating in the microwave oven, the bag comprising:
a base;
a first side extending from the base to a top end of the bag, the first side having a first adhesive field; and
a second side extending from the base to the top end of the bag, the second side having a second adhesive field that cooperates with the first adhesive field to releasably seal the first and second sides together along the top end of the bag, at least one of the first and second adhesive fields being segmented.

18. The bag of claim 17, wherein the second adhesive field is segmented to include a plurality of spaced apart segments, a portion of the first adhesive field on the first side of the bag interfacing with the second side of the bag at a location between the plurality of spaced apart segments of the second adhesive field.

19. The bag of claim 18, wherein another portion of the first adhesive field on the first side of the bag interfaces with the second adhesive field on the second side of the bag.

20. The bag of claim 17, wherein the first and second adhesive fields cooperate to define an X-shaped pattern.

21. The bag of claim 17, further comprising a third adhesive field that extends perpendicular to the first and second adhesive fields to form a pocket seal, wherein the third adhesive field is at least partially segmented.

22. A method of producing a microwave popcorn bag comprising the steps of:
providing a sheet;
folding the sheet to form a first corner fold, the first corner fold being located between a base of the bag and a first side of the bag;
folding the sheet to form a second corner fold, the second corner fold being located between the base of the bag and a second side of the bag, the first and second sides cooperating to define an opening into the bag; and
folding the sheet to form at most one gusset fold that extends substantially parallel to the first and second corner folds, the at most one gusset fold being located in either the first side or the second side of the bag.

23. The method of claim 22, further comprising the step of slicing the sheet to separate the bag from at least a second bag.

24. The method of claim 23, further comprising the step of filling the bag with unpopped popcorn kernels before the slicing step.
